(19) United States
(12) Patent Application Publication
(10) Pub. No.: US 2021/0081585 A1
(43) Pub. Date: Mar. 18, 2021

(54) METHOD FOR EVENT-BASED SIMULATION OF A SYSTEM

(71) Applicant: dSPACE digital signal processing and control engineering GmbH, Paderborn (DE)

(72) Inventor: Stephan SCHEDLER, Paderborn (DE)

(73) Assignee: dSPACE digital signal processing and control engineering GmbH, Paderborn (DE)

(21) Appl. No.: 16/950,422

(22) Filed: Nov. 17, 2020

Related U.S. Application Data
(63) Continuation of application No. PCT/EP2019/062576, filed on May 16, 2019.

(30) Foreign Application Priority Data
May 17, 2018 (DE) 10 2018 111 851.1

(51) Int. Cl. G06F 30/20; G06F 1/04; G06F 9/46; G06F 9/455; G06F 13/38; H04L 12/46; H04L 12/40

(52) U.S. Cl. CPC G06F 30/20; G06F 1/04; G06F 9/468; G06F 2111/02; G06F 13/38; H04L 12/4633; H04L 12/40; G06F 9/45533

(57) ABSTRACT

A method for event-based simulation of a system, the simulation comprising a first computing unit and at least one second computing unit, the first computing unit has a simulation time, the second processor has an operating system layer and an application layer. The second computing unit has a system time in the operating system layer, with at least the second computing unit executing a simulation application. At least one simulation object is executable on the simulation application, and the first computing unit manages an event queue, with at least one event per simulation step being listed in the event queue. The event is associated with a process to be executed by the simulation object and a simulation time provided for execution of the process.

This nonprovisional application is a continuation of International Application No. PCT/EP2019/062576, which was filed on May 16, 2019, and which claims priority to German Patent Application No. 10 2018 111 851.1, which was filed in Germany on May 17, 2018, and which are both herein incorporated by reference.

### BACKGROUND OF THE INVENTION

### Field of the Invention

The present invention relates to a method for event-based simulation of a system.

### Description of the Background Art

In the development of electronic control units, which are also widely known as ECUs, nowadays there is a focus on virtual validation and thus on early testing in the development process. This takes place before the electronic control unit is tested at its destination and often before a prototype of the future control unit hardware is even available. Such a real control device is usually a full-fledged computer with an operating system and input and output interfaces (I/O interfaces) which are connected to a bus system by means of which the control device can communicate with other control devices. The operating system used often must meet real-time conditions, since the control devices are designed to map safety-critical functionality. The control device tasks are mostly of a control and regulation nature and are used, for example, in the automotive sector or in aerospace technology. Examples of such functionalities are the regulation of an internal combustion engine by an engine control unit or the control of driver assistance systems such as speed-adaptive distance regulation. In these areas of application, the networking of the control units with one another is an important aspect, as they are operatively interconnected.

In the early validation mentioned above, software-in-the-loop simulation (also: SIL simulation) is often used, by means of which the finished production code can be tested in a virtual environment without the need for ECU hardware. To this end, virtual electronic control units are used, on which the production code is executed.

Virtual control devices simulate the control device hardware and, like physically present, real control devices, are able to exchange messages with one another via I/O interfaces and bus systems, receive measurements from sensor data and act on actuators. An SIL simulation environment is required for this, simulating the sensor data and the behavior of the bus system, as well as providing the virtual control unit, which stands for the real control unit hardware. This virtual control device then also includes the software components which in a real case belong to the hardware platform and are to be distinguished from the production code executed on it. These software components include, for example, an operating system with kernel and hardware abstraction layer, a run time environment, various services for system and communication, and other components. These functionalities are then simulated virtually and simulated using a simulator. A simulator can be provided, for example, by one or more physically existing computing units that are specialized in the simulation task. It can also be a question of virtually emulated computing units that are run on a commercially available PC. It is also possible to run the virtual control unit on a real-time system such as an HIL simulator. Within the simulator, the virtual control device or devices interact with the simulation environment, which is also referred to below as the simulation application. For this purpose, the virtual control device has an external data interface that allows for messages to be exchanged with a corresponding data interface of the simulation application. This type of simulation is known in the state of the art and can be looked up, for example, in the documentation for the dSPACE SystemDesk V-ECU Generation Module or dSPACE VEOS products.

At this early stage of the ECU development process, it is not yet necessary nor desirable to carry out the simulation under real-time conditions, as is later the case with HIL tests of the finished ECU. Since the control unit is simulated here, the actual control unit clock is also mapped in the simulation. The simulation therefore takes place along a simulated time, also referred to below as the simulation time. This is not necessarily linked to the real time passing outside of the simulation. The simulation time thus behaves asynchronously and can pass faster or slower than the real time, depending on the clock frequency and the number of computing units used, and on whether or not the simulation is stopped. In the case of these simulations, one speaks of offline simulations, which can also be performed on a standard computer.

For such offline simulations, the concept of event-based simulation is used. In event-based simulations, the simulation proceeds along a list of events to be processed. Only the discrete events are simulated at the times at which they are intended in the list, here called an event queue. The time between events is not simulated. This approach makes it possible to simulate long virtual time periods within a short real elapsing time with large increments between two discrete events. In addition, the simulation is dominated by the so-called zero step-time assumption, meaning that the events themselves are believed to be executed instantaneously from the perspective of the simulation time. The execution time that such an event would require on a real ECU is not mapped in the simulation.

The systems made up of control devices in today's motor vehicles are becoming more and more complex, and the tasks that these control devices perform, for example for driver assistance systems—also in the context of the autonomous driving that everyone is striving for—are becoming increasingly extensive. Of course, this also has an impact on the complexity of the testing systems which are used for the early virtual validation of such control unit functions. The resulting simulation models place considerable demands on the computing power and memory requirements of the computer system that is used by the simulator. Against this background, it may be necessary to distribute the calculation of various simulation objects, which can be virtual control devices, for example, over different computing units. It is irrelevant whether the computing units are physically present computing nodes or whether they are computing units virtualized in a hypervisor. This can also be necessary, for example, if simulation objects cannot run on the operating system of the simulator used, or if, as described above, it is necessary to distribute the computing load over several computers.

In this case, a central processing unit, on which the event queue is managed, specifies the applicable simulation time. It will then have the task of triggering the computing units, which are distributed and connected to the central processing unit, to execute an upcoming event. The simulation objects are executed on these in their respective operating systems. It regularly happens that a simulation object makes an operating system call in order to process the upcoming event. In such an operating system call, optionally the time is retrieved from the time base of the distributed system. In this case, however, the time queried in this way by the simulation object does not coincide with the central simulation time, which may lead to incorrect behavior of the simulation.

### SUMMARY OF THE INVENTION

It is therefore an object of the present invention to provide a method for event-based simulation of a system.

According to exemplary embodiment of the the method for event-based simulation of a system, a simulation is carried out on a computer system comprising a first computing unit and at least one second computing unit, the first computing unit having a simulation time, the second computing unit having an operating system layer and an application layer, the second computing unit in the operating system layer having a system time, at least the second computing unit executing a simulation application, at least one simulation object being executable on the simulation application, and the first computing unit managing an event queue, wherein at least one event per simulation step is listed in the event queue, and a process to be carried out by the simulation object and a simulation time point provided for carrying out the process are associated with the event, the second computing unit having a virtual clock generator, the method comprising the following steps for each simulation step of: transmitting, by the first computing unit, a start signal to the virtual clock generator for executing a next simulation step in the second computing unit, and, on the basis of a time difference between a past simulation step and the simulation time, incrementing the system time of the second computing unit, and executing the upcoming process at the simulation time associated with the process.

In the context of the method according to the invention, a computer system can be understood to be a network of computing units, each of which has its own operating system and on which applications can be executed. In this computer system there is a first computing unit, which is referred to in the following as the central processing unit, from which the progress of the simulation is managed. In addition, the computer system contains a second or a plurality of further computing units that are connected to the first computing unit via a bus system. The bus system can be based on Ethernet or other bus systems. The further computing units are called distributed computing units, on which the simulation is executed. The simulation includes the execution of one or more simulation objects on the distributed computing units or also on the central processing unit. These simulation objects can be, for example, virtual ECUs, Simulink models, functional mock-up units (FMUs), or virtual ECUs based on an AUTOSAR standard. The simulation objects involved can be operatively connected. This means for example that when executing the simulation, a simulation object sends the calculation result of a process to another simulation object and the latter performs further processes in a subsequent simulation step based on this calculation result. The calculation result can be sent by means of the bus system.

To carry out the simulation objects, simulation applications are executed on the distributed computing units. This can be understood to mean an application that manages the simulation objects associated with it and starts the processes that are associated with the managed simulation objects. In addition, the simulation application receives calculation results from simulation objects on other computing units for further processing by simulation objects associated with it and/or forwards calculation results of the simulation objects associated with it to simulation objects on other computing units.

In this context, event-based simulation of a system can be understood to mean a simulation that progresses on the basis of a list of events to be processed, which in this case is called the event queue. Here, the time that elapses between the events is not simulated. The progress of the simulation is based on the simulation time, which is specified by the central processing unit that manages the event queue. The central processing unit can use its internal hardware clock for this purpose, for example. For each event, the event queue lists a process to be executed and a simulation time at which the execution is to take place, as well as, if applicable, a message to the executing computing unit. As soon as the simulation time of an event has arrived, the latter is carried out and transfers the simulation to the next simulation state. If the simulation object to which the next upcoming event is assigned is on one of the distributed computing units, the correct time for executing the associated process is initially unknown from the perspective of the simulation object. This is due to the fact that the simulation object readily receives the system time of the computing unit back when time queries are sent to the operating system of the distributed computing unit. However, said system time does not necessarily match the simulation time. Therefore, the method according to the invention provides using virtual clock generators on the distributed computing units, which function as timers for the operating system on the respective computing unit. At the beginning of each simulation step, said clock generator receives a start signal for this simulation step from the first computing unit. Said start signal contains the information that the next simulation step can be carried out. How this information is transmitted does not matter. In the simplest case, one bit is sufficient, such as a rising edge or a change from 0 to 1.

By means of the start signal and the information contained therein about the simulation time, the second computing unit can now increment its system time to the correct simulation time. This is to be understood in such a way that the second computing unit knows the applicable simulation time from the past simulation step and the system time that is appropriate at this point in time. At the start of the new simulation step, the second computing unit now receives the simulation time applicable for this simulation step. The second computing unit can then correct its system time by the time difference between these two simulation times—the past and the new simulation step. The upcoming process in the new simulation step is then calculated at the correct simulation time.

The method according to the invention enables an advantageous decoupling of the event-based simulation from the real time running outside of the simulation. This makes it possible to reliably reproduce simulation results, which would not be the case without the invention. It is also possible to run the simulation faster or slower than in real time and to pause it.

The time difference between the past and the new simulation step can be already calculated by the first calculating unit and is transmitted with the start signal to the virtual clock generator on the second or another distributed computing unit.

The current simulation time can be first transmitted from the first computing unit together with the start signal to the second or a further distributed computing unit. The simulation application on the second computing unit then forms the time difference and the virtual clock generator increments the system time such that it corresponds to the simulation time.

The first and second or further distributed computing units can comprise network interfaces by means of which communication between the computing units is made possible via the bus system.

The simulation objects can be executed on the same operating system as the simulation application that manages the simulation objects. The operating system used can be based on Linux and/or be a real-time operating system, for example. Since the simulation objects can make operating system calls during the simulation, the respective operating system is to be regarded as part of the simulation.

The simulation objects can be executed in a closed environment. This means that the simulation objects are only allowed access to hardware resources to the extent necessary for the simulation. In particular, access of the simulation objects to the system time of the distributed computing unit is prevented, since otherwise synchronization with the simulation time would no longer be guaranteed. The simulation objects can be allowed access to hard disk space, network interface, main memory, processor cores and others in the closed environment, which can be a sandbox, for example.

The first and the second or further distributed computing units can have virtual network interfaces by means of which communication between the computing units is made possible via a virtual bus system. This enables the simulation to be carried out on a plurality of virtual computing nodes.

One or more of the simulation objects in the simulation can be provided by virtual control devices which simulate the behavior of physically present control devices. A virtual control device can be understood to be a software application that simulates the extensive components of a series control device such as runtime environment, system services, communication services or hardware abstraction layer, so as to be able to be simulated in a simulator.

The calculation results of the simulation objects can be transmitted from the virtual network interface of first computing unit via a network tunnel to the virtual network interface of a second computing unit.

The computing units used can be physical computing nodes.

The computing units used can be virtual computing nodes, the operating system of which is executed by, for example, a hypervisor.

The virtual clock generator can be implemented in the application layer.

The virtual clock generator can be implemented in the operating system layer.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic view of an embodiment of the invention with a system made up of three computing units;

FIG. 2 is a representation of the timing of an event-based simulation on two computing units using the method known from the prior art; and

FIG. 3 is a representation of the timing of an event-based simulation on two computing units using the method according to the invention

### DETAILED DESCRIPTION

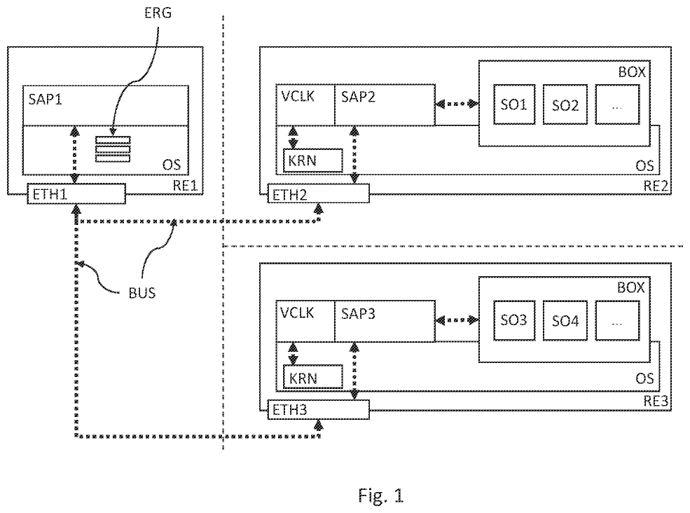

FIG. 1 shows an illustration of an embodiment of the invention on a distributed computer system which comprises three computing units RE1, RE2 and RE3. The number of computing units in this exemplary embodiment is chosen arbitrarily. Just as it is sketched in FIG. 1 and explained below, the invention would also work on a computer system consisting of two, four or more computing units. It is also irrelevant whether the computing units are present as physical computing cores or virtual computing nodes. The computing units RE1, RE2 and RE3 each have an operating system OS on which in each case a simulation application SAP1, SAP2 or SAP3 is executed. The operating system OS is not necessarily the same on every computing unit. The task of the simulation application SAP1 on computing unit RE1 is to manage an event queue, which is processed to carry out the event-based simulation. The event queue includes a list of events, and a mapping of the processes TASK associated with the events and the information at which point in the simulation time are to process the listed events, as well as the information as to which computing unit is scheduled to carry out the run. When the simulation is carried out, the simulation application SAP1 sends a start signal on the central processing unit RE1 to the simulation application SAP2 and SAP3, which is provided for executing the upcoming event.

The simulation applications SAP2 and SAP3 on the computing units RE2 and RE3 are tasked in turn with initiating the computing of the events by the respective responsible distributed computing unit RE2 or RE3 as soon as the starting signal S1 has been received and the moment of the simulation time has arrived at which the event is to be processed by the computing unit that is associated with the event. After the event has been processed, the simulation application of the respective executing computing unit sends a completion signal S2 (not shown in FIG. 1) to the simulation application SAP1 on the central processing unit RE1. The completion signal signals that the event has been processed.

To exchange the start and completion signals, the computing units RE1, RE2, and RE3 each also have a network interface ETH1, ETH2, and ETH3, which are connected to a bus system BUS, which allow for the simulation applications SAP1, SAP2 and SAP3 to exchange messages between the central processing unit RE1 and the distributed computing units RE2 and RE3. These network interfaces ETH1, ETH2, and ETH3 can be implemented, for example, by an Ethernet controller. The computing units then exchange messages based on an Ethernet protocol.

In the exemplary embodiment on which FIG. 1 is based, the role of the computing unit 1 is to form a central processing unit, while computing units RE2 and RE3 represent distributed computing units. In addition to the components already described, computing units RE2 and RE3 each have a virtual clock generator VCLK, an operating system kernel KRN and a closed environment BOX. The simulation objects associated with the respective distributed computing unit RE2 or RE3 for execution are run in the closed environment BOX, wherein the simulation objects SO1 and SO2 are associated with the computing unit RE2 and the simulation objects SO3 and SO4 to the computing unit RE3. This closed environment can be a sandbox, for example, or a kernel namespace if the operating system OS used on the respective computing unit RE2 or RE3 is Linux-based. The task of the closed environment is to ensure that the simulation objects executed in it only have access to the hardware resources associated with them. These hardware resources can be, for example, hard disk storage, the network interfaces ETH2 or ETH3, one or more processor cores, or the main memory.

In this embodiment, the computing units RE2 and RE3 each have a virtual clock generator VCLK. The task of the virtual clock generator VCLK is to increment the system time in the operating system kernel KRN of the distributed computing units according to a clock difference determined between a past simulation step and the simulation time applicable at the time of determination. In this sense, the virtual clock generator is to be understood as a virtual replacement for the original clock that the computing unit in question would use to increment its system time. Since the determined clock difference is directly related to the simulation time, which is specified by the central computing unit RE1, the distributed computing units thus indirectly use the central simulation time as the system time. The determination of the clock difference can take place by the virtual clock generator VCLK itself, or it can already have been calculated by the first computing unit RE1 and transmitted to the virtual clock generator. In both cases, the virtual clock generator uses the clock difference to increment the system time in the distributed computing unit—in this exemplary embodiment computing units RE2 or RE3—and to synchronize it with the simulation time.

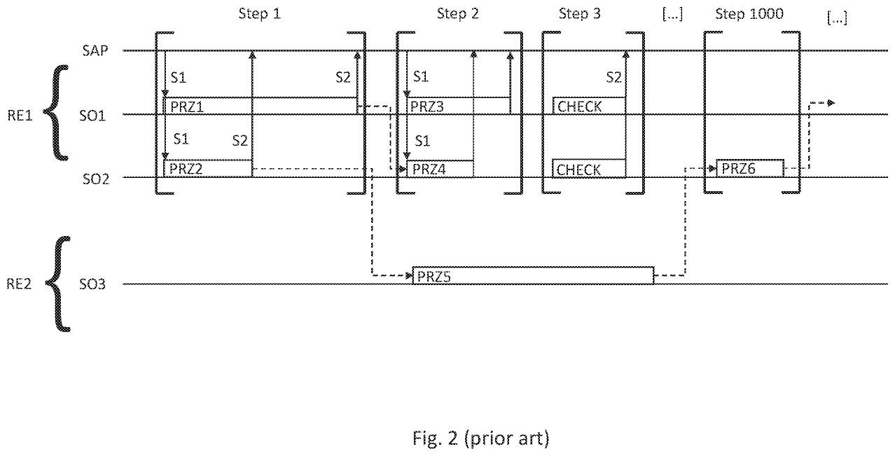

In the illustration in FIG. 2, there is a sketch of the time sequence of an event-oriented simulation according to the method as is known in the prior art. In this example there are two computing units RE1 and RE2. The number is chosen completely arbitrarily here; the depicted situation would also present itself on three or more computing units.

FIG. 2 shows the timing of the execution of the processes, of the simulation objects SO1 and SO2 on the computing unit RE1 shown in the upper system, and of the simulation object SO3 on the computing unit RE2 shown in the lower system. The simulation objects SO1, SO2, and SO3 can be virtual control devices, for example. In this example, the first computing unit RE1 is designed as a simulator, that is to say a simulation application SAP is executed on the computing unit RE1. Said application manages the event queue (not shown) and starts the execution of the processes that are next in the event queue by means of the simulation objects SO1 and SO2 by transmitting a start signal S1. The computing unit RE2 is a distributed component which is executed separately from the computing unit RE1 and the simulation application running on it. The simulation object SO3 is executed on the computing unit RE2.

The first simulation step, Step 1, starts with the start signal S2, and the simulation objects SO1 and SO2 respectively perform the processes PRZ1 and PRZ2. As soon as they have completed these, they report the completion back to the simulation application SAP with a completion signal S2. In this example, simulation object SO1 is finished first, followed by simulation object SO2. Once both simulation objects tasked with processes are finished, the simulation step ends. After completion of the simulation step, the calculation results of the simulation objects are transmitted to other simulation objects that require the calculation result for their next process executed. In the example, the calculation result of simulation object SO1 is transmitted to simulation object SO2 via a bus system before the start of simulation step, Step 2. The calculation result of simulation object SO2 is required for the next simulation step of simulation object SO3 and is transmitted to the latter.

With the next start signal S1, the next simulation step, Step 2, starts, and on computing unit RE1, simulation object SO1 performs the process PRZ3, simulation object SO2 performs the process PRZ4 using the calculation result of Step 1 of simulation object SO1, and on computing unit 2, the simulation object SO3 performs the process PRZ5. As soon as the simulation objects SO1 and SO2 have finished calculating their processes—PRZ3 and PRZ4—they again report a completion signal S2 to the simulation application SAP. Since simulation object SO3 is not simulated synchronously in this example, but instead only reacts to the calculation results of simulation object SO2, the simulation step ends before the simulation object SO3 can finalize the calculation of the process PRZ5. While the calculation continues here, further processes are simulated in simulation objects SO1 and SO2. In the simplest case, these are CHECK processes which only check as to whether there are new calculation results. If this is not the case, the simulation step is ended again by reporting the completion signal S2 to the simulation application SAP. This query is repeated and simulation steps are accumulated until a simulation object SO3 provides a new calculation result for SO2. In this exemplary embodiment, this is the case when the simulation object SO3 on computing unit RE2 has finished calculating the process PRZ5. After the end of the calculation, simulation object SO3 sends its calculation result to the previously specified recipient—here it is the simulation object SO2—which writes it into a buffer in the following simulation step, Step 1000. In this example, the calculation result of PRZ5 can only be transmitted to simulation object SO2 in simulation step, Step 1000. Since each simulation step is assigned a simulation time, SO2 incorrectly receives the calculation result at the 1000th simulation time, although the calculation result should already be available after the second simulation step due to the zero step-time assumption.

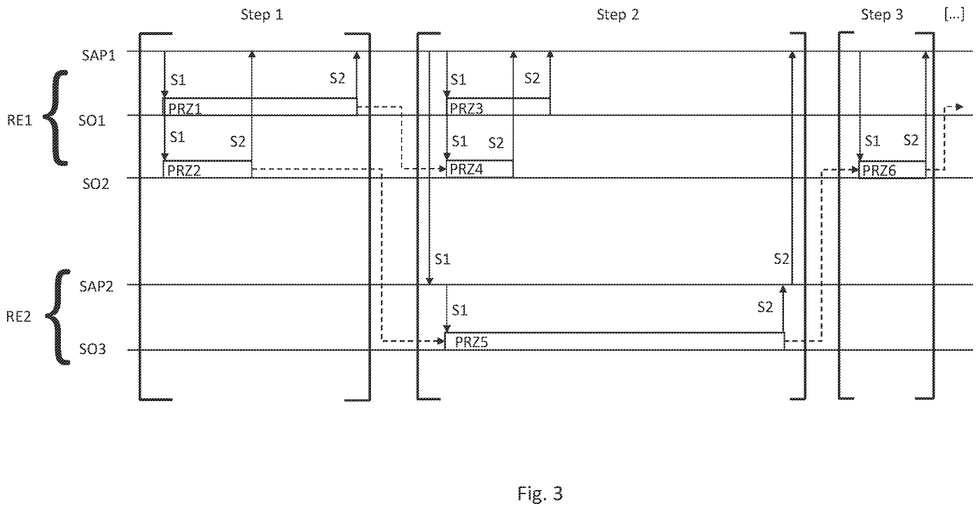

The illustration in FIG. 3 shows a sketch of the timing of an event-oriented simulation using the method according to the invention.

FIG. 3 shows the timing of the execution of the processes, of the simulation objects SO1 and SO2 on the computing unit RE1 shown in the upper system, and of the simulation object SO3 on the computing unit RE2 shown in the lower system. The simulation objects SO1, SO2, and SO3 can be virtual control devices, for example. In this example, the first computing unit RE1 is designed as a simulator, that is to say a simulation application SAP1 is executed on the computing unit RE1. The former manages the event queue (not shown) and starts the execution of the processes that are next in the event queue using the simulation objects SO1 and SO2 and SO3 by transmitting a start signal S1. The computing unit RE2 is a distributed component which is executed separately from the computing unit RE1 and the simulation application SAP1 running on it. A simulation application and the simulation object SO3 are executed on computing unit RE2.

The first simulation step, Step 1, starts with the start signal, and the simulation objects SO1 and SO2 respectively perform the processes PRZ1 and PRZ2. As soon as they are finished, they report the completion back to the simulation application SAP 1 with a completion signal S2. In this example, simulation object SO1 is finished first, followed by simulation object SO2. The simulation step ends as soon as both simulation objects assigned with processes are finished. After the simulation step has been completed, the simulation objects transmit their calculation results to other simulation objects that need the calculation result for their next process executed. In the example, simulation object SO1 transmits its calculation result to simulation object SO2 via a bus system before the start of simulation step, Step 2. The calculation result of simulation object SO2 is required for the next simulation step by simulation object SO3 and is transmitted to it. A network tunnel, for example (indicated by the dashed arrow), which enables communication between the simulation objects on different computing units, can be used to transmit the calculation result.

The next simulation step, Step 2, starts with the next start signal S1, and simulation object SO1 performs the process PRZ3 on computing unit RE1; simulation object SO2 performs the process PRZ4 using the calculation result of simulation object SO1 from Step 1. The already completed process PRZ2 has initiated a subsequent process PRZ5 that is to be performed on computing unit 2 by the simulation object S03. After completion of simulation step, Step 1, the simulation object SO2 sends its calculation result to the simulation object S03. With the start signal S1, the computing unit RE2 implicitly receives the information about the simulation time and can increment its system time accordingly. The simulation object SO3 can then start with the calculation of the process PRZ5 at the right simulation time that is stored in the event queue.

As soon as the simulation objects SO1 and SO2 have finished calculating their processes—PRZ3 and PRZ4—they again report a completion signal S2 to the simulation application SAP1. While the simulation objects SO1 and SO2 have finished their calculations, the calculation of the process PRZ5 continues on the computing unit RE2. In contrast to the example described with respect to FIG. 2, the simulation step is not yet completed at that time. This is due to the fact that the simulation time on which the calculation of all processes is based is known to both computing units RE1 and RE2 and is identical during all simulation steps.

After the calculation of the process PRZ5 on computing unit RE1 has been completed, the calculation result is sent to the simulation object SO2 on computing unit RE1.

Since the simulation is performed under a zero step-time assumption, no simulation time elapses during the calculation of the processes. The simulation step, STEP 2, is therefore not completed until the calculation of the process PRZ5 on computing unit RE2 by simulation object SO3 has been completed. During this time, from the point of view of the simulation, no time passes.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for event-based simulation of a system, the method comprising:
providing a computer system to perform the simulation, the computer system comprising a first computing unit and at least one second computing unit, the first computing unit having a simulation time, the second computing unit having an operating system layer and an application layer, the second computing unit having a system time in the operating system layer;
performing, via the second computing unit, a simulation application, at least one simulation object being executed on the simulation application; and
managing, via the first computing unit, an event queue, wherein in the event queue at least one event is listed for each simulation step, and the at least one event is associated with a process to be executed via the simulation object and with a simulation time point provided for the execution of the process;
providing the second computing unit with a virtual clock generator;
transmitting, via the first computing unit, a start signal to the virtual clock generator for executing the next simulation step in the second computing unit;
incrementing, based on a time difference between a past simulation step and the simulation time, the system time of the second computing unit; and
executing the upcoming process at the simulation time point associated with the process.

2. The method according to claim 1, wherein the time difference between the past simulation step and the simulation time is calculated by the first computing unit and is transmitted to the second computing unit with the start signal.

3. The method according to claim 1, wherein the simulation time is transmitted by the first computing unit with the start signal to the second computing unit and the second computing unit calculates the time difference between the past simulation step and the simulation time.

4. The method according to claim 1, wherein the first computing unit has a first network interface and the second computing unit has a second network interface, wherein the first and second network interfaces are interconnected via a bus system, and wherein the transmission of the start signal takes place via the network interface and the bus system.

5. The method according to claim 1, wherein the simulation objects are executed on the same operating system as the associated simulation application.

6. The method according to claim 5, wherein the simulation objects are executed in a closed environment, wherein the simulation objects in the closed environment are granted access to a first set of hardware resources of the computing unit associated with the simulation application, and wherein the first set of hardware resources are defined by the simulation application.

7. The method according to claim 6, wherein the simulation objects in the closed environment are denied access to a second set of hardware resources of the computing units associated with the simulation application.

8. The method according to claim 5, wherein at least two of the simulation objects each have a virtual network interface, wherein the virtual network interface is able to receive or send calculation results via a virtual bus system.

9. The method according to claim 5, wherein at least one of the simulation objects on the first or second computing unit is a virtual control device.

10. The method according to claim 8, wherein the calculation results is sent from the virtual network interface of a first computing unit via a network tunnel to the virtual network interface of a second computing unit.

11. The method according to claim 5, wherein the computing units are physical computing nodes.

12. The method according to claim 7, wherein at least one computing unit is a virtual computing node, the operating system of the respective computing unit being executed by a hypervisor.

13. The method according to claim 1, wherein the virtual clock generator is implemented in the application level.

14. The method according to claim 1, wherein the virtual clock generator is implemented at the operating system level.
